(19) United States
(12) Patent Application Publication
(10) Pub. No.: US 2009/0217657 A1
(43) Pub. Date: Sep. 3, 2009

(54) Wave Energy Extraction Device

(76) Inventor: Christopher Anthony Budd, Dorset (GB)

Correspondence Address: KLARQUIST SPARKMAN, LLP, 121 SW SALMON STREET, SUITE 1600, PORTLAND, OR, 97204, US

(21) Appl. No.: 12/086,934

(22) PCT Filed: Dec. 21, 2006
(86) PCT No.: PCT/GB2006/004853

§ 371 Date: May 7, 2009

(30) Foreign Application Priority Data
Dec. 23, 2005 (GB) 0526335.5
Oct. 12, 2006 (GB) 0620254.3

(51) Int. Cl. F03B 13/00

(52) U.S. Cl. 60/495

(57) ABSTRACT

A wave energy extraction device comprises a plurality of generally vertically extending plate assemblies (9a, 9b, 9c), each plate assembly being mounted on respective generally upright arms 7′, the lower ends of which are pivotally attached to a basal frame (5a, 5b), about substantially parallel, horizontally spaced-apart pivotal axes (13). At least one energy absorber (17a; 36, 38′; 71, 72) has direct or indirect respective drive connections (19a, 19b; 61, 65) with the adjacent plate assemblies. The arrangement of the drive connections is such that relative displacement of the adjacent plate assemblies (9a, 9b; 9b, 9c) towards and/or away from each other, as accommodated by pivotal movements of one or both plate assemblies relative to the basal frame about the pivotal axes (13), results in operation of the energy absorber. The distance between a first and second plate assembly (9a, 9b) is desirably twice the distance between the second plate assembly (9b) and a third plate assembly. In one embodiment, FIG. 1, the energy absorber (17a) is mounted on top of a plate assembly (9b) and driven by a mechanical connection (19a), but in another embodiment, FIG. 5, the energy absorber (71, 72) is connected by hydraulic lines (61, 65) to hydraulic cylinders (55, 56) connected to the plates.

The invention relates to wave energy extraction devices.

The invention relates more particularly, but not exclusively, to inventive modifications of the wave energy extraction devices set out in published International Patent application WO2005/045136.

According to a first aspect of the invention described in that application we provided a breakwater device in which one or more energy absorbers arranged between a plurality of structures having neutral buoyancy are adapted to permanently remove energy from waves by resisting the relative motion of the structures caused by opposing forces which are created between those structures by virtue of the fact that the structures are located in different parts of the irrotational oscillating cycle of the water mass which occurs naturally during the passage of waves.

The structures are advantageously plate like and arranged substantially parallel to each other.

There is a problem with this arrangement in that the plates are able to move freely during the oscillation of the waves, constrained only by the resistance due to the energy absorber. Although the plates do not need significant mooring (as we explain in the above-mentioned application), we have found that over time the plates may move out of position, due to higher order wave effects, or other external factors such as current and wind direction. If the plates are not substantially parallel with each other, or if the plates are not in line with each other, the efficiency of the energy extraction can be reduced.

We now consider it to be desirable to constrain the unwanted motion of the plates, while still allowing the plates to move relative to each other as a result of their being located in different parts of the irrotational flow of the water mass.

According to a first aspect of the present invention we provide a wave energy extraction device comprising a plurality of generally vertically extending plate assemblies (but which may be in a horizontal position in transit), each plate assembly being mounted on respective generally upright arms, the lower ends of the arms of adjacent plate assemblies being pivotally attached to a basal frame, about substantially parallel, horizontally spaced-apart pivotal axes, and at least one energy absorber having direct or indirect respective drive connections with the adjacent plate assemblies, the arrangement of the drive connections being such that relative displacement of the adjacent plate assemblies towards and/or away from each other, as accommodated by pivotal movements of one or both plate assemblies relative to the basal frame about said pivotal axes, results in operation of the energy absorber.

The arms mounting a respective plate assembly may form part of a generally upright framework secured to the respective plate assembly.

Preferably there are three such plate assemblies, and drive connections with the plate assemblies are so arranged that a first energy absorber is responsive to relative movement of first and second plate assemblies towards and away from each other, and a second energy absorber is responsive to relative movement of the second and third plate assemblies towards and away from each other, whereas synchronised motion of adjacent plates transmits rather than absorbs wave energy.

The distance between the first and second plate assemblies is preferably substantially twice the distance between the second and third plate assemblies.

The distance between a pair of plate assemblies is preferably (n+½)λ where n is a positive integer including zero, and λ is a component wavelength present in the water mass in the location in which it is intended to position the device in use.

Most preferably the distance between the first and third plate assemblies is half the maximum wavelength prevailing in the wave climate in which the device is located in use.

The basal frame allows the plate assemblies to move towards and away from each other, but can be made sufficiently rigid to restrict undesirable twisting or horizontal shearing motions between the plate assemblies, by substantially limiting the motions of the respective frameworks of the plates to motion about the pivotal axes. Some twisting motions may be allowed if such are necessary to relieve stress on the plate assemblies.

The pivotal attachments are preferably arranged to constrain the angular motion of the plate assemblies about the pivotal axes when the device is in use to closely follow the irrotational pattern of the water mass. As is explained in more detail below, the irrotational oscillation of the water mass reduces with increasing depth from the surface.

Preferably the pivotal axes are located at a depth at which the irrotational oscillation is substantially zero. In general this depth will be at a distance above the seabed.

Most preferably the pivotal axes are located at a depth at which the irrotational oscillation is less than 5% of the amplitude of the irrotational oscillation at the water surface.

The basal frame preferably extends generally horizontally in use.

Preferably the basal frame is generally rectangular. Most preferably the basal frame acts as a keel for the device.

Drive connections from adjacent plate assemblies to the energy absorber may be direct mechanical connections, or they may be indirect hydraulic connections.

The energy absorber in one embodiment is mounted on the top of one plate assembly, and a mechanical drive connection with an adjacent plate assembly is made by way of a horizontal rod that is pivotally attached at its free end to the upper end of said adjacent plate assembly. This arrangement has an advantage that the energy absorber is accessible for maintenance on partial raising of the energy extraction device, but on a relatively long device suitable for long-wavelength waves the rods have to span a relatively large distance, and may be difficult to support.

When hydraulic connections are provided, then the energy absorber may be supported on or in the basal frame, rather than adjacent to the water level.

One advantage of the foregoing arrangement is that if the basal frame is capable of being made buoyant, it becomes possible to arrange for the plate assemblies to be stowed in substantially horizontal positions, by for example incorporating releasable pivots in the arms.

The basal frame preferably comprises two laterally spaced-apart pontoons that are capable of being charged with air in order to raise the device for maintenance and towing, said pivotal axes extending transversely of the pontoons.

The dimensions of the pontoons are preferably such that when charged with air they are sufficiently buoyant to constitute a floating catamaran which supports the remaining structure of the device above the water.

The pontoons are preferably in the form of elongate cylinders with rounded or pointed ends to provide reduced drag during towing.

The pontoons preferably constitute the principal longitudinal members of the basal frame.

The basal frame is preferably provided with substantially horizontal vanes, preferably one adjacent to each corner of the basal framework, in order to resist heave of the device.

The wave energy extraction device is preferably arranged to float at a level which provides a freeboard along the plate assemblies corresponding to approximately half wave height of the maximum normal operating wave height climate. This may be achieved by providing floats on the upper regions of the respective arms or frameworks. Alternatively, the plate assemblies themselves may comprise floats.

This buoyancy enables the device to be used in all depths of water, except where the depth is less than the draft of the basal frame.

When the floats are independent units, the floats preferably extend beyond the planes of the plate assemblies in a direction parallel to the longitudinal axis of the basal frame. Thus water flow around the edges of the plates due to the differences in wave height (level differences) across the plates is reduced. Most preferably such floats are substantially oblong, and are provided with a tapered region at either end.

When the plate assemblies themselves comprise floats, the floats are preferably each in the form of an elongate buoyancy chamber which constitutes an upper portion of a plate assembly and extends laterally of the device. The buoyancy chambers may be of substantially rectangular cross-section in the fore-and-aft vertical plane, i.e. in a plane perpendicular to the pivotal axes of the plate assemblies, and preferably each plate assembly comprises a pair of spaced-apart walls extending downwardly from the front and rear walls respectively of the buoyancy chamber, to facilitate water flow up and down the walls.

The walls may extend in planes that include the pivotal axis of the respective plate assembly, and diverge from one another proceeding in the upward direction.

The energy absorber or absorbers are preferably immersed below the static water level in order to reduce the problems of corrosion which can arise with water spray in air, particularly with salt water spray, to provide cooling.

In one embodiment employing direct mechanical connections with the plate assemblies, the energy absorber comprises a hydraulic piston and cylinder assembly driving one or more electrical generators the electrical generator/s being housed within a generator housing that conveniently is supported by one of the plate assemblies and is disposed substantially on the opposite side of the plate assembly from the hydraulic piston and cylinder assembly.

The housing for the electrical generator/s is preferably of substantially elongate box shape and arranged substantially in line with the piston and cylinder assembly which drives the generator/s.

The generator housing may then be supported from the associated frame assembly substantially about its centre of mass and buoyancy in gimbals, to facilitate the relative movement of the plate assemblies.

When hydraulic drive connections are used to transmit relative movement of first and second plate assemblies towards and away from each other to the energy absorber associated therewith, the arm or arms mounting the first plate assembly is preferably connected to a first double-acting hydraulic piston and cylinder assembly, and the arm or arms mounting the second plate assembly is preferably connected to a second hydraulic double-acting piston and cylinder assembly, a first hydraulic line connects a chamber of the first double-acting assembly with a second chamber of the second double-acting assembly, and a second hydraulic line connects the other chamber of the first double-acting assembly with the other chamber of the second double-acting assembly, and a hydraulic cross connection being provided between the first and second hydraulic lines, the energy absorber being so arranged as to be responsive to any flow through the cross-connection, the connections being made with said chambers in the sense that, synchronised motion of the first and second plate assemblies about said pivotal axes can occur through flow between the double-acting assemblies but without cross flow between the first and second lines, and hence without the extraction of wave energy, any flow through the cross-connection resulting from any relative movement of the first and second plate assemblies towards or away from one another.

When there is a third plate assembly, and a second energy absorber responsive to relative movement of the second and third plate assemblies, a third double-acting piston and cylinder assembly is preferably connected to the arm or arms mounting the second plate assembly, and a fourth double-acting piston and cylinder assembly is preferably connected to the arm or arms mounting the third plate assembly, a third hydraulic line connects a chamber of the third piston and cylinder assembly with a chamber of the fourth piston and cylinder assembly, and a fourth hydraulic line connects the other chamber of the third assembly with the other chamber of the fourth assembly, and a second hydraulic cross connection is provided between the third and fourth hydraulic lines, the second energy absorber being so arranged as to be responsive to any flow through the second cross-connection, the connections being made between the chambers of the third and fourth assemblies in the sense that synchronised pivotal motion of the second and third plate assemblies can occur through flow between the third and fourth piston and cylinder assemblies without cross flow between the third and fourth lines.

According to a second aspect of the invention a method of generating power from water waves in a body of water comprises arranging the device in accordance with the first aspect of the invention with the basal frame submerged at an intermediate depth in the water such that the upright plate assemblies are subject to the irrotational flow of the water mass associated with water waves.

Some preferred embodiments of the present invention will now be described, by way of example only, with reference to the accompanying drawing in which

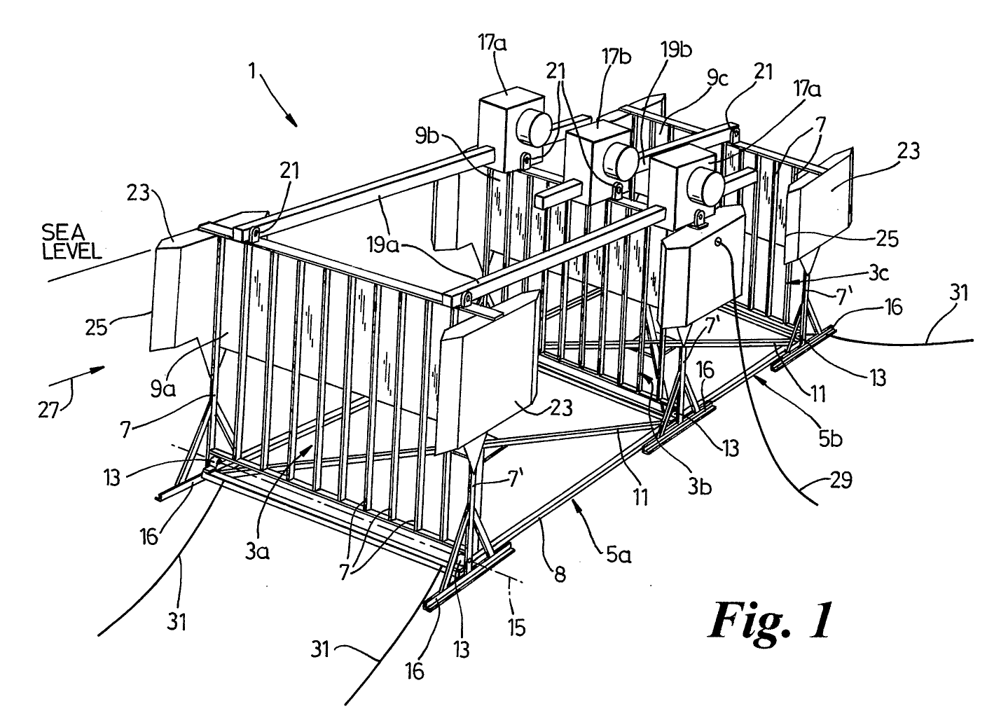

FIG. 1 shows a perspective view of a first wave energy extraction device in accordance with the invention,

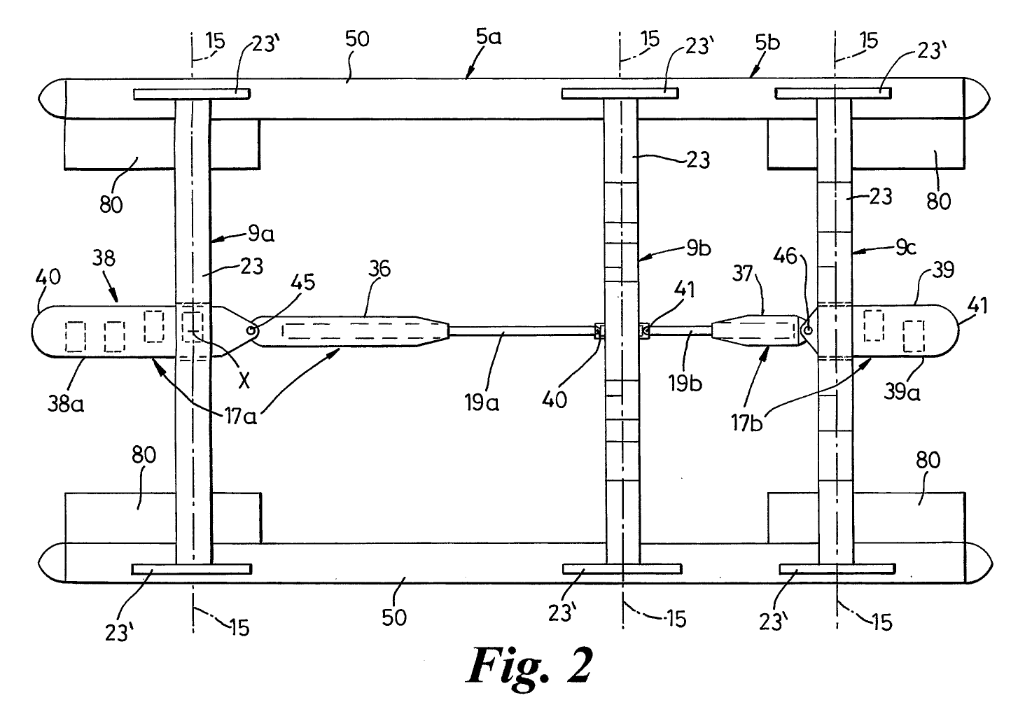

FIG. 2 is a plan view of a second wave energy extraction device in accordance with the invention, but omitting the catamaran framework,

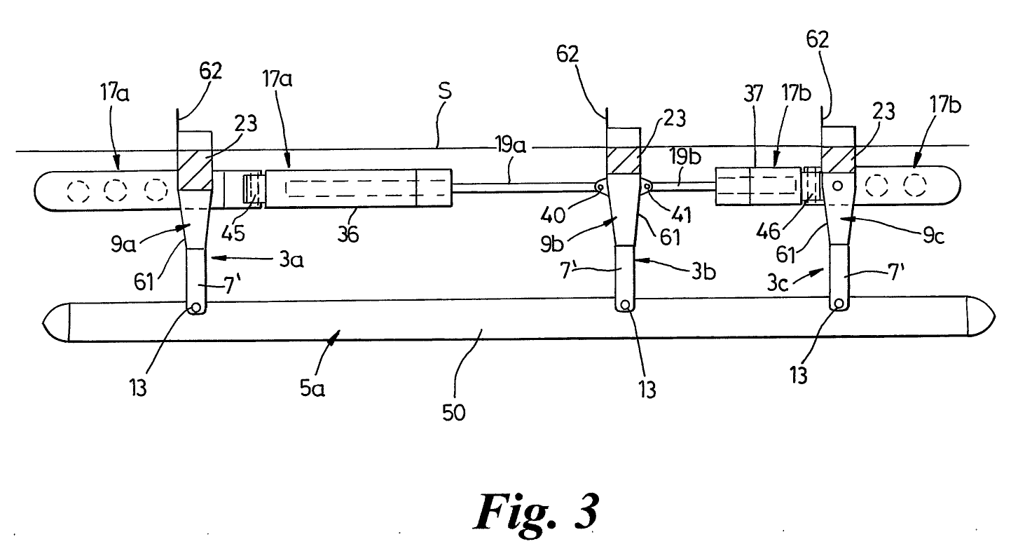

FIG. 3 is a side elevation of the device of FIG. 2 in a position of use,

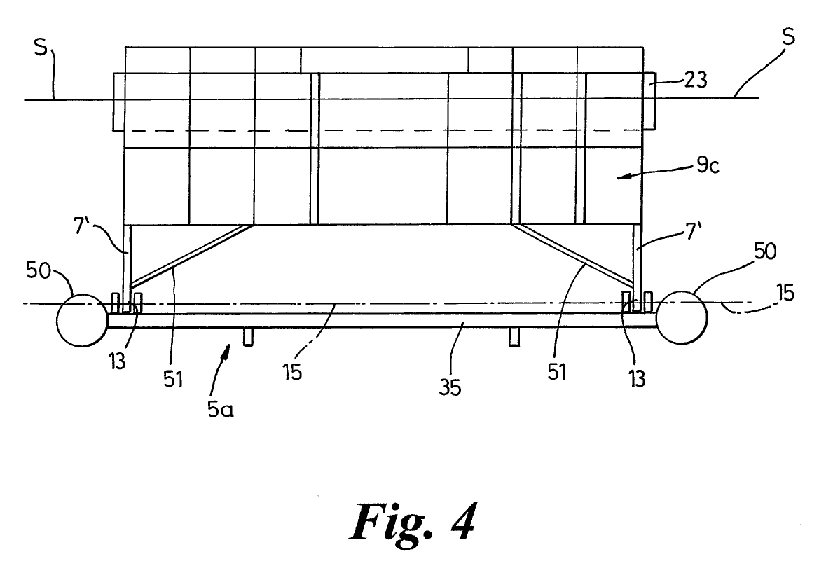

FIG. 4 is an end view of the device of FIG. 2 looking from the right in FIG. 2 but omitting the hydraulic cylinders and the energy absorbers, and

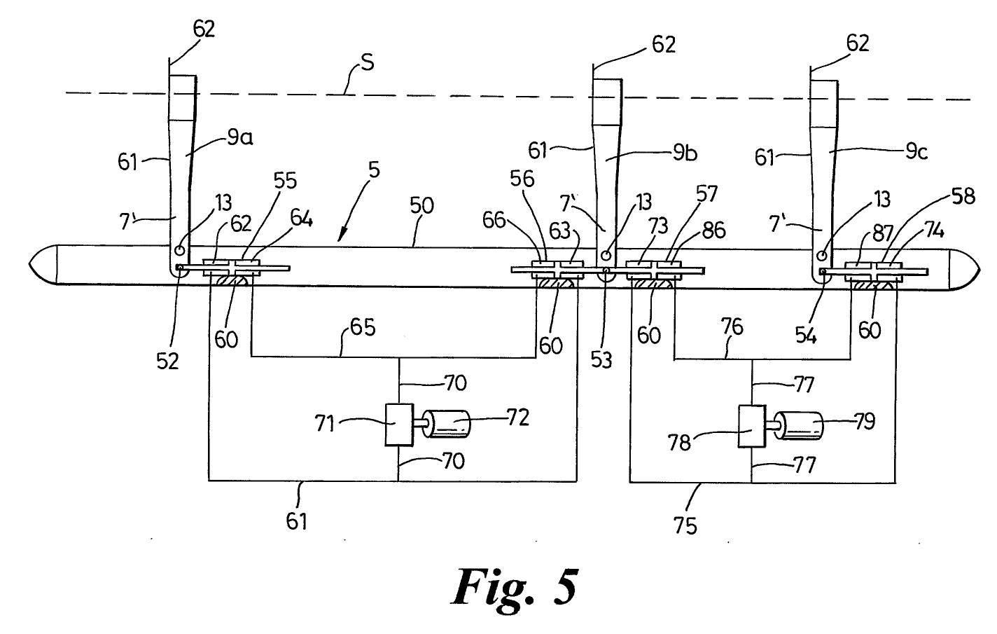

FIG. 5 is a schematic side elevation similar to FIG. 3 of a third wave energy extraction device in accordance with the invention and including a hydraulic circuit diagram.

Before describing the construction of the energy extraction devices in more detail, the theory on which the device is based will be briefly described.

Energy is transmitted through a body of water by means of a coherent oscillatory motion of the water mass about a relatively fixed datum, which moves only gradually in the wave direction. This motion is known as an irrotational oscillation. Each fluid particle describes a circle or an ellipse about a point that is substantially stationary relative to the seabed. The presence or absence of this irrotational motion is the only difference between still water and that which has waves passing across it.

The coherent oscillatory motion of the water mass extends downwards from the surface, reducing exponentially in amplitude to about 5% of its size at the surface at a depth of ½ wavelength (λ/2). The oscillatory motion in the water is phase dependant. That is to say, when it is oscillating in the wave direction, it creates a crest and when it is oscillating against the wave direction it creates a trough. The momentum, force applied and distance traveled by the coherent mass of fluid in the wave is substantially the same in all directions, with fluid particles returning to almost the same position, relative to the datum, at the end of each cycle. The wave profile and its motion across the water, therefore, only represent the transmission of energy through the water and not the motion of the water mass itself.

It can be shown that wave energy is transferred only by the difference in potential energy (height) of the coherent water mass when oscillating with the wave direction at the crest to that of the same water mass when oscillating against the wave direction in the trough. The fluid motion described is in accordance with the Bernoulli steady state integrated equation of motion and assumes irrotational flow and invariant fluid density throughout the bulk of the fluid. This theory therefore underpins the primary mechanism of energy transfer through water in the form of waves and is the theory on which this application is based.

As a wave cycle passes, a floating structure transcribes a circle or an ellipse about a point, of diameter approximately equal to the wave height and so moves backwards and forwards relative to a datum by a total distance (measured at the water surface) of approximately the wave height. The structure itself, however, has minimal effect upon the passage of the wave, and is virtually transparent to the passage of the energy. The structure does not itself rotate.

If the horizontal motion of the structure is resisted, the whole oscillating mass of the water reacts on it and generates large forces in the process. Since this is an oscillating process, the direction of action of the forces reverses twice during the passage of each wave cycle. For this reason vertical plates positioned one wavelength apart are always acted upon by forces and displacements in the same direction. However, plates, located half a wavelength apart, will always be acted upon by equal forces and displacements in opposite directions.

The part of the oscillatory cycle experienced by a plate depends upon its position relative to the part of the wave passing overhead. Also, as the depth at which the plate is located increases, the size of the oscillation excursion reduces until below a certain depth it tends to disappear. Therefore a plate will move relative to any other plate located in a different part of the water mass, as the waves pass overhead, and the distance between the plates will continuously change. The one exception to this is if plates are positioned exactly one wavelength apart in the horizontal direction as detailed above. The orientation of the structures however will not substantially change during the oscillation process.

Two fundamental properties of the energy extracting device can be defined from the above, and from the more detailed analysis set out in our co-pending International Patent application number WO2005/045136. Firstly, plates placed one wavelength apart oscillate in a circular or elliptical pattern relative to the seabed, but in unison and without measurable differential motion between them. Secondly, plates placed half a wavelength apart oscillate in the same pattern, but diametrically opposed to each other, and create a differential motion approximately equivalent to two wave heights each wave cycle at the sea surface.

When the plates are positioned one wavelength apart, and fixed together, wave energy passes right through the plates virtually unaffected; whereas when the plates are positioned approximately half a wavelength apart, or (n+½)λ wavelengths apart where n is a positive whole number including zero, theoretically energy can be extracted up to a quantity equal to the total amount available in the wave, by adjusting the resistive force (back pressure) of an energy absorber adapted to extract energy from the relative displacement occurring between the plates.

Referring now to FIG. 1, a wave energy extracting device 1 is shown, having three upright rectangular frameworks 3a, 3b and 3c, and two rectangular horizontal basal frames 5a and 5b. It can be seen that frames 5a and 5b are in fact portions of a single larger frame, but it is convenient to consider those portions as separate frames.

The frameworks 3 each are formed with a series of vertical bars 7. The basal frames 5 have a rectangular outer frame provided with diagonal bracing bars 11. Water is able to pass unimpeded between the bars of the frameworks 3 and basal frames 5.

Secured to the upper region of each framework 3 is a respective plate assembly 9, which is shown as being formed from a single piece of material.

Frameworks 3a and 3b are pivotally secured to opposite ends of a basal frame 5a, and frameworks 3b and 3c are pivotally secured to opposite ends of basal frame 5b, by pivots 13 that connect with the outermost vertical bars 7′. Bars 7′ constitute arms connecting the respective plate assembly 9 with the basal frame 5a or 5b. The pivots 13 allow a frame 3 to deviate from its initial upright position by rotation about a pivotal axis 15 (only shown in respect of the first framework 3a) if a force is applied to a plate 9.

Each framework is provided with two braced feet 16, one on each side of the lower portion of the framework, adjacent the pivots 13. The feet protrude either side of the pivots 13, so as to keep each framework 3 in a substantially vertical position when the device is not in use, for example, when the device is in dry-dock.

Mounted on the central framework 3b are energy absorbers 17a and 17b. Energy absorbers 17a are connected to framework 3a by sliding rods 19a. Energy absorber 17b is connected to framework 3c by sliding rod 19b. The energy absorbers 17 and rods 19 are connected to the frameworks 3 by pivots 21, allowing them to rock back and forth as the frameworks 3 pivot, thus avoiding putting bending stress on the rods 19.

It can be seen that energy absorber 17a, for example, is in driving connection with the plates 9a and 9b, via frameworks 3a and 3b, rod 19 a and pivots 21. This means that when the device 1 is in use, the relative motion of the frameworks 3 caused by the force of the water on the plates 9 results in the operation of the energy absorbers 17.

Floats 23 are connected to either side of the upper region of each framework 3 in order to provide buoyancy for the device 1. The floats are roughly of oblong shape, with tapered ends 25, as will be explained in more detail below.

In use, the device is arranged to float so that the energy absorbers are positioned just above the surface of the water, to allow for easy access and help reduce corrosion due to seawater. The buoyancy of the floats should be chosen in order to achieve this, having in mind the materials from which upright frameworks 3, basal frames 5 and plates 9 are made. As would be apparent to the skilled man, the closer the combined density of the frames 3 and 5 and the plates 9 can be made to the density of seawater, the less need there will be for floats. For example, the plate 9 itself could be made of a low density material, or be hollow, in order to act as a float and suspend the frames 3 and 5.

The operation of the device of FIG. 1 is as follows. The device is positioned at sea such that each plate presents a major face to the prevailing direction of wave propagation, and so blocks the flow of water through the upper region of its respective framework 3. This means that when the device is in use the water mass will act on each plate ad cause it to move in the direction of the water movement about that plate, to the extent that the plate is not prevented from doing so by its respective framework 3 and/or base plate 5.

A wave incident on the device, as indicated by arrow 27, causes the plates 9 to move. As explained above, the passage of a wave causes the fluid particles to move in circular or elliptical orbits, returning to substantially the same position once the wave has passed as that at which the particle started. If the plates are positioned such that they experience different parts of the oscillation at the same time the plates will move relative to each other as the wave passes. The only time at which the plates will not move relative to each other is if they are positioned exactly the same distance apart as the wavelength of the wave passing through them, such that they experience exactly the same oscillatory forces as each other at the same time. The energy absorber can extract energy whenever there is relative motion between the plates, and transmits energy whenever there is similar motion between the plates.

The greatest relative motion occurs between two plates which are positioned approximately half of the prevailing wavelength of the water in which the device is positioned apart. This is because when plate 9a, for example, experiences a wave crest, plate 9b positioned half a wavelength away experiences a wave trough, and so the plates 9 always experience substantially the same horizontal force due to the wave, but in opposite directions. The plates reach their furthest horizontal excursions (when the wave is halfway between crest and trough, and the horizontal force on each is zero) at the same time, but are each on the opposite side of their respective centre of oscillation.

However, the motion of the sea is not regular, but instead the water mass oscillates as a result of the combination of many different wavelengths. The composite oscillation of the water mass can be treated as being made up of a number of individual wavelengths A, each of which can be considered as acting on the device separately from each other wavelength. Whether energy is transmitted or extracted between two plates depends on how the plates react to each individual component wavelength λ.

Providing three plates provides three different combinations of plates between which energy can be permanently extracted by the energy absorbers: plates 9a and 9b, positioned 22 metres apart; plates 9b and 9c positioned 11 metres apart; and plates 9a and 9c, positioned 33 metres apart. Each combination of plates can extract energy with maximum efficiency from a wave of wavelength λ if the spacing between those plates is equal to (n+½)λ, where n is a positive whole number including zero. However, if the spacing between those plates is (n+1)λ then the energy of a wave of wavelength λ is transmitted by those plates. If the spacing between the plates is between those two extremes, then some energy will be extracted, and some energy will be transmitted through the plates.

It will be seen that in a three plate arrangement it is unlikely for a wave to have a wavelength that is exactly equal to the spacing between every pair of plates at the same time, and so most waves will cause some relative motion between at least one pair of plates. For example, a wave may have a wavelength equal to the spacing between the first two plates, and so be completely transmitted through the first pair of plates. However, if the distance between the second pair of plates is half the distance between the first, then the energy of the wave will be completely extracted by the second pair of plates. As the energy absorbers can extract some energy from any wave that causes some relative motion between the plates, at least some energy will be extracted from the majority of waves passing through the device, resulting in a net reduction of the energy of the wave system.

The pivots 13 allow the frameworks 3 to move back and forth as the wave passes, but do not allow the frameworks 3 to move sideways, or to twist relative to one another, or otherwise move out of alignment, other than if such movements are necessary to relieve stress from the plate assemblies. The pivots only allow the frameworks to deviate a limited amount from the vertical, so as to constrain the angular motion of the frameworks to substantially follow the irrotational pattern of the water mass.

The frameworks 3 are of sufficient height that the basal frames 5 are positioned substantially below the oscillation caused by the passage of the wave, and so the lower margins of the frameworks and the pivotal axes 15 remain relatively stationary during the passage of the wave. It will be observed that the plates 9 only restrict the flow of water through the upper regions of the frameworks 3. This is because, as explained above, the majority of energy transmitted by a wave is transmitted close to the surface of the water. The height of the frameworks 3 (and so the depth at which the basal frame 5 is positioned) also affects how closely the motion of the frameworks is able to follow the irrotational motion of the water mass. For example, it can be seen that a framework the height of which is much greater than the depth to which the irrotational motion of the water mass extends cannot mimic the motion of the water mass at every point. Either the horizontal excursion of the framework will be greater than the horizontal excursion of the fluid particles near the base of the plate assembly, resulting in some energy being used to move the plate against the water mass or, the horizontal excursion of the framework will be less than that of the fluid particles near the surface of the water, resulting in less energy being extracted than is available in the wave.

The rods 19a are pushed by framework 3a when the plate 9a is pushed in the direction of wave propagation 27 (during a wave crest) and are pulled by the framework 3a when the plate 9a is pushed against the direction of wave propagation (during a wave trough). This reciprocating motion drives the energy absorbers 17a. It will be appreciated that plate 9b is continuously acted on in an opposite manner to plate 9a, and so at any one time the energy absorbers 17a move in the opposite direction to the rods 19a, effectively doubling the travel of the rods.

The energy absorbers extract energy by resisting the relative motion between adjacent plates. The energy absorbers 17 could be hydraulic pistons, electromagnetic arrangements or any other suitable means of permanently extracting energy from translational motion. Energy that is extracted can be supplied to storage means (not shown) or directly to the national grid, via cable 29.

As energy is extracted the wave height reduces, resulting in a difference in wave height on either side of a plate. The floats 23, as well as providing buoyancy for the device, restrict the flow of water around the ends of the plates 9, which would otherwise be encouraged by that level difference, thereby increasing the capture efficiency of the device. The ends of the floats are tapered so as to reduce the effect of the force of the water on the ends of the floats, which may be in a opposite sense to the force on the plate to the framework of which the floats are attached, as the ends of the floats are likely to be located in a different part of the irrotational flow cycle to that plate.

The basal frames 5 act as a keel, which provides a gravitational restoring force able to drive the assembly to a position in which the frameworks are substantially upright once operating loads have been removed.

When the device is in use it is desirable to provide mooring lines 31. Mooring may be provided only at the end of the device which is facing the incident wavefront, in order to combat second order wave effects which cause the water mass and anything in it to move slowly in the general direction of the waves. Preliminary tests have shown that the device tends to align itself such that the plates are perpendicular to the prevailing wave direction, and so mooring the device only at that end allows it to turn somewhat if the prevailing direction of waves changes over time. However, mooring could also be provided at the rear of the device to combat other factors, such as wind and current, which might cause the device to drift out of position. By ‘rear’ it is meant the end of the device facing away from the incident wavefront. Strictly speaking the device cannot be said the have a front or back, as it can operate equally well in either direction.

By connecting the mooring lines 31 to the basal frame the plate assemblies are partially isolated from the moorings by the vertical frameworks, enabling a large part of any shock loadings (due, for example to unusually large waves) to be absorbed, thus reducing the mooring specification requirements.

The two basal frames are shown in FIG. 1 as being two portions of a larger frame. However, it is contemplated that instead two basal frames could be hinged, or otherwise pivotally attached, in order to provide some flexibility, allowing the central upright framework with its respective plate to move vertically with respect to the other frameworks and plates.

The plates 9 are shown as being all the same size. However, this need not be the case. For example, the plate at the side of the device facing the incident waves may be arranged to be deeper than the plate at the other side of the device, because the first plate will experience larger waves when the device is in use.

It is also contemplated, in a modification of the device of FIG. 1 in which the feet 16 are omitted, that the basal frame might be arranged to rest on the seabed while the device is in use, with the frameworks being held generally upright by floatation means.

Referring now to FIGS. 2, 3 and 4, which show a development of the device of FIG. 1, parts corresponding to those of the device of FIG. 1 have been given corresponding reference numerals.

In the device of FIGS. 2, 3 and 4 the basal frame 5 comprises a pair of pontoons 50 extending longitudinally of the device, the pontoons 50 being connected by a catamaran framework comprising a plurality of transverse bars 35, one of which is shown in FIG. 4. The pontoons are capable of being charged with air to raise the device from the normal position shown.

The three pivotal plate assemblies 9a, 9b, and 9c each comprise a buoyancy chamber 23 of rectangular transverse cross-section, and extending for the full width of the top of the respective plate assembly, and a pair of flat plate skirts 61 which, as shown in FIG. 3, lie in planes that include the pivotal axis 15 of the associated pivots 13, such that the front and rear sides of each plate assembly 9a, 9b, 9c slope downwards, as seen in FIG. 3. In FIG. 3 the crosshatched portions of the buoyancy chambers 23 are the portions that are providing buoyancy when the device is floating as shown with the sea level part-way up the buoyancy chambers. The plate assemblies also comprise respective vertical extensions 62, extending upwardly from the buoyancy chambers 23 by a distance such that the freeboard along the plate assemblies 9a, 9b, 9c corresponds to approximately half wave height of the maximum normal operating wave climate. Additionally, the plate assemblies are each provided with end plates 23′ at their opposite ends, the plates being of similar outline to those of FIG. 1, but not including a buoyancy chamber (the end plates 23′ have been omitted from FIG. 3 for clarity).

The frame assemblies 3a, 3b, 3c are provided with braces 51 connecting with the arms 7′, FIG. 4, to resist sideways distortion of the frame assemblies.

In this embodiment the rod 19a forms the piston rod of an hydraulic piston and cylinder assembly 36, and the rod 19b forms the piston rod of hydraulic piston and cylinder assembly 37.

Piston and cylinder assembly 36 is responsive to the relative movement of the frame assemblies 9a and 9b, whereas piston and cylinder assembly 37 is responsive to the relative movement of the frame assemblies 9b and 9c.

Energy absorbers 17a, 17b comprise respective generator units 38, 39, which are carried by the respective plate assemblies 9a, 9c, the generator units 38, 39 comprising respective elongate box-shaped generator housings 38a, 39a having rounded ends 40, 41 facing forwards and aft of the device.

The housings 38, 39 contain electrical generator sets 38′ and a respective swash-plate hydraulic motor for driving the generators in response to hydraulic pressure generated in the piston and cylinder assemblies 36, 37.

The housing 38a of unit 38 is supported in an aperture in plate assembly 3a in gimbals, not shown, at the centre of mass and buoyancy X of the unit 38.

Similarly the unit 17b extents through an apertures in plate assembly 9c and is similarly supported there in gimbals.

The adjacent ends of piston rods 19a and 19b and pivotally attached to the intermediate plate assembly 9b by horizontal pivots 40, 41.

The inwardly facing ends of the housings 38a, 39a are connected by vertical pivots 45, 46 to the respective hydraulic assemblies 36, 37 which permit some flexing of the basal frame in use.

The positioning of the lines of action of the piston and cylinder assemblies 36 and 37 below the water level surface S can enable the line of action to coincide substantially with the centre of pressure of irrotation of the water for the predominant wave length of waves in the intended location of the device.

Horizontal vanes 80, shown in FIG. 2 but omitted from FIGS. 3 and 4 for clarity, are provided at opposite ends of the pontoons 50 to resist heave of the structure.

Suitable props may be provided to maintain the plate assemblies in a generally upright position when the pontoon is raised for maintenance or towing of the device.

FIG. 5 shows a significant modification to the device of FIGS. 2 to 4, and corresponding parts have been given corresponding reference numerals in the drawings. In the embodiment of FIG. 5 the three upright plate assemblies 9a, 9b, 9c are indirectly connected to energy absorbers by way of hydraulic connections to be described.

The arms 7′ of the plate assemblies 9a, 9b, 9c are extended downwards below the respective pivots 13 to provide pivotal connections 52, 53, 54 with double-acting piston and cylinder assemblies 55, 56, 57 and 58.

In particular, the pivotal connection 52 of the first plate assembly 9a is connected to the piston rod of first piston and cylinder assembly 55, the cylinder of which is housed within one of the pontoons 50 and anchored thereto by a cylinder mounting 60. Second piston and cylinder assembly 56, and third piston and cylinder 57 have their piston rods connected by a common pivotal connection 53 to the arm 7′ mounting the second plate assembly 96. The piston rod of the fourth piston and cylinder assembly 58 is connected at 54 to the arm 7′ of the third plate assembly 9c.

A first hydraulic line 61 connects a first chamber 62 of first piston and cylinder assembly 55 with a second chamber 63 of the second piston and cylinder assembly 56, such that when the first and second plate assemblies move in the same pivotal direction and at the same rate about pivots 13, fluid will flow between chambers 62 and 63 to accommodate this movement. The other chamber 64 of the assembly 55 is connected by a second line 65 to the other chamber 66 of the second piston and cylinder assembly 56, and fluid can also pass between said chambers 64, 66 when the first and second plate assemblies 9a, 9b move relative to the basal frame in the same direction.

A cross-connection 70 is provided between the two hydraulic lines 61, 65, and in the cross-connection 70 is provided a hydraulic motor 71 driving an electrical generator 72. When, as just described, the first and second plate assemblies 9a, 9b swing in the same direction and by the same amount relative to the basal frame 5, then there is no tendency for fluid to flow through the cross-connection 70, but when the first and second plate assemblies 9a, 9b are urged relative to one another by the action of a wave, some hydraulic flow will pass through cross-connection 70 against the resistance provided by the linked motor and generator 72, and electrical power will be generated.

The third piston and cylinder assembly 57 has a chamber 73 connected to a chamber 74 of the fourth piston and cylinder assembly 58 by a third hydraulic line 75, and the other chambers 86, 87 of the assemblies 57, 58 are connected by a fourth hydraulic line 76. A second hydraulic cross-connection 77 between the third and fourth lines 75, 76 contains a second hydraulic motor 78 connected to a second electrical generator 79.

It will be appreciated that the hydraulic circuits associated with the first and second plate assemblies 9a, 9b, provide indirect drive connections to the hydraulic motor and generator assembly 71, 72 which constitute an energy absorber responsive to displacement of the first and second plate assemblies 9a and 9b towards and away from each other.

Similarly the hydraulic motor and generator assembly 78, 79 constitute an energy absorber responsive to displacement of the second and third plate assemblies 9b and 9c towards and away from each other.

It will be appreciated that there is no hydraulic connection between the hydraulic circuits 61, 65 associated with the first and second plate assemblies 9a, 9b, and the hydraulic circuits 75, 76 associated with the second and third plate assemblies 9b, 9c.

The electrical output of the generators 72 and 79 can be connected in known manner to an electrical supply.

In the embodiment of FIG. 5 the spacing-apart of the first, second and third plate assemblies 9a, 9b, 9c can be as discussed in relation to FIG. 3.

Although the piston and cylinder assemblies 55, 56, 57 and 59 are shown as being located internally of a pontoon 50 they may be mounted externally of the pontoons if so desired. Similarly, the hydraulic motors 71, 78 and generators 72, 79 may be mounted internally of a pontoon, or externally.

In a modification to the device of FIG. 5, the double-acting piston and cylinder assemblies are each replaced by respective single-acting piston and cylinder assembly, and flow to and from the assemblies and one or more hydraulic motors, and one or more hydraulic accumulators, is controlled by servo-controlled valves, the control system for controlling the valves being arranged to cause the hydraulic motor/s to be driven in response to relative movement of adjacent pairs of plates towards and away from one another, but not in response to synchronised motion of an adjacent pair of plates.

In the devices described the forces opposing pivotal movement of the plate assemblies relative to the basal frame could be arranged to be such that the plate assemblies can each pivotally resonate at the frequency of the predominant wavelengths of waves in the location.

1-28. (canceled)

29. A wave energy extraction device comprising a plurality of plate assemblies that extend generally vertically in use, each plate assembly being mounted on respective generally upright arms, the lower ends of the arms of adjacent plate assemblies being pivotally attached to a basal frame, about substantially parallel, horizontally spaced-apart pivotal axes, and at least one energy absorber having respective drive connections with the adjacent plate assemblies, whereby displacement of the adjacent plate assemblies relative to one another, as accommodated by pivotal movements of at least one of said plate assemblies relative to the basal frame about a respective one of said pivotal axes, results in operation of the energy absorber.

30. A device as claimed in claim 29 in which there are three such plate assemblies.

31. A device as claimed in claim 29 in which the distance between a pair of plate assemblies is (n+½)λ where n is a positive integer including zero, and λ is a component wavelength present in the water mass in the location in which it is intended to position the device in use.

32. A device as claimed in claim 29 in which the basal frame extends generally horizontally, and is generally rectangular.

33. A device as claimed in claim 32 in which the basal frame acts as a keel for the device.

34. A device as claimed in claim 29 in which the basal frame is provided with substantially horizontal vanes, arranged to resist heave of the device.

35. A device as claimed in claim 29 in which the plate assemblies themselves comprise floats.

36. A device as claimed in claim 29 in which each energy absorber is immersed below the static water level.

37. A device as claimed in claim 29 in which the energy absorber comprises a hydraulic piston and cylinder assembly driving at least one electrical generator, said electrical generator being housed within a generator housing that is supported by one of the plate assemblies and is disposed substantially on the opposite side of the plate assembly from the hydraulic piston and cylinder assembly.

38. A device as claimed in claim 29 in which hydraulic drive connections are used to transmit relative movement of first and second plate assemblies to the energy absorber associated therewith.
